(19) United States
(12) Patent Application Publication
(10) Pub. No.: US 2025/0067842 A1
(43) Pub. Date: Feb. 27, 2025

(54) SYSTEM, PROCESSING DEVICE, AND STORAGE MEDIUM

(71) Applicant: KABUSHIKI KAISHA TOSHIBA, Tokyo (JP)

(72) Inventors: Emi KAKISADA, Ota Tokyo (JP); Hiroki MORI, Kawasaki Kanagawa (JP)

(73) Assignee: KABUSHIKI KAISHA TOSHIBA, Tokyo (JP)

(21) Appl. No.: 18/800,168

(22) Filed: Aug. 12, 2024

(30) Foreign Application Priority Data
Aug. 24, 2023 (JP) 2023-136499

(51) Int. Cl. G01S 7/40; G01S 13/88

(52) U.S. Cl. CPC G01S 7/4039; G01S 13/887

(57) ABSTRACT

According to one embodiment, a system includes a sensor in which at least one of an installation location and a configuration is changeable, a controller for driving the sensor and processing a sensor signal, and a processor for storing device information indicating at least one of the installation location and the configuration, receiving type information indicating a type of the sensor, and transmitting a program based on the type information and the device information to the controller.

### CROSS-REFERENCE TO RELATED APPLICATIONS

This application is based upon and claims the benefit of priority from Japanese Patent Application No. 2023-136499, filed Aug. 24, 2023, the entire contents of which are incorporated herein by reference.

### FIELD

Embodiments described herein relate generally to a system, a processing device, and a storage medium for ensuring the security of a space.

### BACKGROUND

Security systems which detect predetermined objects to ensure the security of public spaces have been developed. Examples of these systems include a radar. This radar irradiates a space in which the inspection target is present with electromagnetic waves and determines whether or not the inspection target possesses predetermined objects based on the reflected waves.

There are various types of spaces in which the security should be ensured. The operation of the radar needs to be adjusted based on the installation environment, the types of the predetermined objects to be detected, etc. To adjust the operation of the radar, advanced expertise is required. Therefore, the radar cannot accurately determine whether or not the predetermined objects are possessed in some cases.

### BRIEF DESCRIPTION OF THE DRAWINGS

FIG. 1 is a block diagram showing an example of a radar system according to an embodiment.

FIG. 2 is a block diagram for explaining an example of a radar device according to the embodiment.

FIG. 3A is a diagram for explaining a first example of the layout of the radar modules according to the embodiment.

FIG. 3B is a diagram for explaining the first example of the layout of the radar modules according to the embodiment.

FIG. 4A is a diagram for explaining a second example of the layout of the radar modules according to the embodiment.

FIG. 4B is a diagram for explaining the second example of the layout of the radar modules according to the embodiment.

FIG. 5A is a diagram for explaining a third example of the layout of the radar modules according to the embodiment.

FIG. 5B is a diagram for explaining the third example of the layout of the radar modules according to the embodiment.

FIG. 6 is a block diagram for explaining an example of a control device according to the embodiment.

FIG. 7 is a block diagram for explaining an example of a processing device according to the embodiment.

FIG. 8 is a diagram for explaining an example of device information according to the embodiment.

FIG. 9 is a diagram for explaining an example of a process in a development phase of the processing device according to the embodiment.

FIG. 10 is a diagram for explaining an example of a process in a development phase of the processing device according to the embodiment.

FIG. 11 is a diagram for explaining an example of a process in a development phase of the processing device according to the embodiment.

FIG. 12 is a diagram for explaining an example of a process in a development phase of the processing device according to the embodiment.

FIG. 13 is a diagram for explaining an example of a process in an operation phase of the processing device according to the embodiment.

FIG. 14 is a diagram for explaining an example of a process in an operation phase of the processing device according to the embodiment.

FIG. 15 is a diagram for explaining an example of a process in an operation phase of the processing device according to the embodiment.

### DETAILED DESCRIPTION

Embodiments will be described below with reference to the drawings. In the following descriptions, a device and a method are illustrated to embody the technical concept of the embodiments. The technical concept is not limited to the configuration, shape, arrangement, material or the like of the structural elements described below. Modifications that could easily be conceived by a person with ordinary skill in the art are naturally included in the scope of the disclosure. To make the descriptions clearer, the drawings may schematically show the size, thickness, planer dimension, shape, and the like of each element differently from those in the actual aspect. The drawings may include elements that differ in dimension and ratio. Elements corresponding to each other are denoted by the same reference numeral and their overlapping descriptions may be omitted. Some elements may be denoted by different names, and these names are merely an example. It should not be denied that one element is denoted by different names. Note that “connection” means that one element is connected to another element via still another element as well as that one element is directly connected to another element. If the number of elements is not specified as plural, the elements may be singular or plural.

In general, according to one embodiment, a system includes a sensor device in which at least one of an installation location and a configuration is changeable; a control device configured to drive the sensor device and process a sensor signal output from the sensor device; and a processing device configured to store device information indicating at least one of the installation location and the configuration for each type, receive type information indicating a type of the sensor device, and transmit a program based on the type information and the device information to the control device.

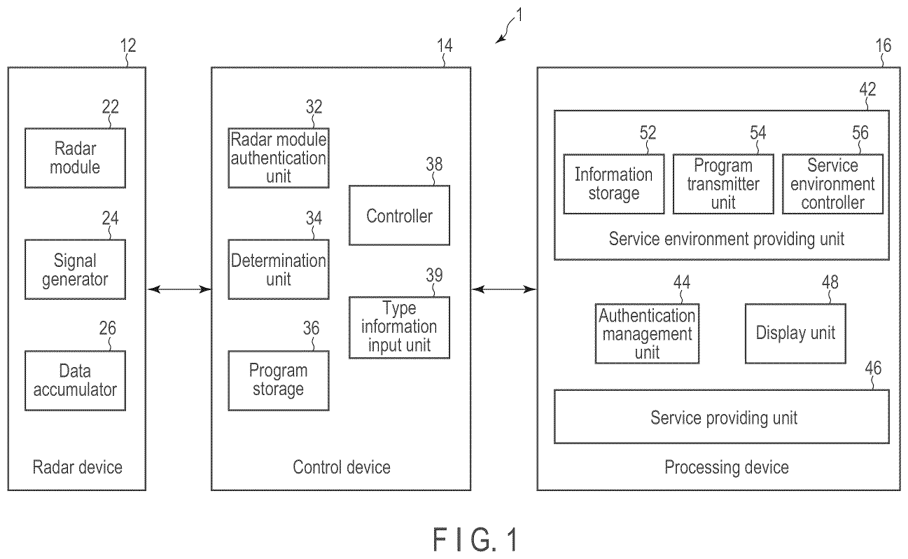

FIG. 1 is a block diagram for explaining an example of a system 1 according to an embodiment. The system 1 determines whether or not the inspection target possesses predetermined objects. Examples of the predetermined objects include dangerous objects such as metal, firearms, blades, combustibles, explosives, and batteries. The system 1 includes a radar device 12 as a sensor device, a control device 14, and a processing device 16. The radar device 12 and the control device 14 may be connected to each other either by wire or wirelessly. The control device 14 and the processing device 16 may be connected to each other either by wire or wirelessly. The system 1 may include a plurality of radar devices 12 and a plurality of control devices 14. The control devices 14 may be connected to the processing device 16 via a network. Another example of the sensor device includes a camera which captures the inspection target, and an image analysis device.

The radar device 12 includes radar modules 22, a signal generator 24, and a data accumulator 26. The radar device 12 can inspect the inspection target in various types of spaces. The radar device 12 can be installed at any place.

The signal generator 24 generates a signal based on the signal from the control device 14. The output signal of the signal generator 24 is supplied to the radar modules 22. The radar modules 22 operate based on the output signal of the signal generator 24.

The configuration of the radar modules 22 can be changed based on the types of the predetermined objects, the shape of the inspection target, the shape of the inspection area in which the inspection target is present, etc. Examples of the configuration of the radar modules 22 include the number of radar modules 22 and the installation locations of the radar modules 22.

Each of the radar modules 22 includes a transmission function and transmits electromagnetic waves to the inspection target based on the output signal of the signal generator 24. Wavelengths of the electromagnetic waves may be 1 mm to 30 mm. The electromagnetic waves having wavelengths of 1 mm to 10 mm are called millimeter waves. The electromagnetic waves having wavelengths of 10 mm to 100 mm are called microwaves. The electromagnetic waves may be terahertz waves having wavelengths of 100 μm to 1 mm.

Each of the radar modules 22 includes a reception function. Each of the radar modules 22 receives reflected waves from the inspection target, and outputs a received signal based on the output signal of the signal generator 24. A predetermined module is selected as a transmitter module from the radar modules 22. The selection of the transmitter module is changed for each transmission.

Electromagnetic waves are transmitted in series from all of the radar modules 22. The reflected electromagnetic waves are received in a plurality of radar modules 22 at the same time.

The electromagnetic waves are reflected on portions of the inspection target. For example, the skin and possessed predetermined objects reflect the electromagnetic waves. The skin, metal, an explosive, and the like have different reflectances for electromagnetic waves. Therefore, the types of substances on which the electromagnetic waves are reflected can be identified from the strength of the received signal. When an image is generated based on the strength of the received signal, the shape of each possessed item can be recognized. In addition, whether or not the possessed item is a predetermined object can be recognized based on the shape. Each of the radar modules 22 can amplify the received signal. The received signal is supplied to the data accumulator 26. The data accumulator 26 transmits the received signal to the control device 14.

The radar device 12 is categorized into different types based on the number of the radar modules 22 and layout of the radar modules 22, the types of the predetermined objects, the shape of the inspection target, the shape of the inspection area, etc. The driving and controlling methods of the radar device 12 differ depending on the type.

The control device 14 includes a CPU, a graphic processing unit (GPU) or a field programmable gate array (FPGA) for running a computer program which drives and controls the radar device 12 or a combination of them. The program is transmitted from the processing device 16. The program corresponds to the type of the radar device 12. The program includes information which specifies the transmission order of the radar modules 22, information which indicates the amplification factor etc., of the received signal based on the positional relationship between each transmitter module and each receiver module, information which indicates the type of the signal process of the received signal and the like. The control device 14 controls the transmission and reception of the radar modules 22 in accordance with the program. The control device 14 includes a radar module authentication unit 32, a determination unit 34, a program storage 36, a controller 38, and a type information input unit 39.

The radar module authentication unit 32 authenticates each of the radar modules 22. An authentication key is determined for each of the radar modules 22. The radar module authentication unit 32 includes key input function. The operator of the control device 14 inputs the authentication keys of all of the radar modules a 22 by using the key input function. The radar module authentication unit 32 determines whether or not the input key is coincident with the authentication key of each of the radar modules 22. When the keys are coincident with each other, the authentication of the radar module 22 succeeds. When the keys are not coincident with each other, the authentication fails.

When the authentication of all of the radar modules 22 succeeds, the radar module authentication unit 32 causes the controller 38 to be operable. Thus, when the radar device 12 consists of only authenticated radar modules 22, the control device 14 drives and controls the radar device 12. When the authentication of at least one of the radar modules 22 fails, the radar module authentication unit 32 causes the controller 38 to be inoperable. Thus, when any one of the radar modules 22 included in the radar device 12 is unauthenticated, the control device 14 cannot drive or control the radar device 12. This configuration prevents the use of the radar device 12 if it includes an unauthenticated radar module 22.

The program storage 36 stores the program transmitted from the processing device 16. Examples of the program storage 36 include a nonvolatile memory or a nonvolatile memory.

Examples of the nonvolatile memory include a flash memory. Examples of the volatile memory include a DRAM.

The controller 38 runs the program and drives and controls the radar device 12 based on the program.

The type information input unit 39 inputs type information which indicates the type of the radar device 12. Examples of the input include a manual input by the operator of the control device 14 and the acquisition of type information transmitted from the radar device 12.

The determination unit 34 can apply a signal process to the received signal transmitted from the radar device 12 and determine whether or not the inspection target possess a predetermined object. The type of the signal process of the determination unit 34 is determined by the program run by the controller 38. In the signal process, an image may be generated or no image may be generated. Examples of the image include information which allows the recognition of the possessed predetermined object. The operator may determine whether or not the inspection target possesses the predetermined object based on the image. The controller 38 may determine whether or not the inspection target possesses the predetermined object based on the image. The determination unit 34 transmits the result of determination to the processing device 16. When the determination unit 34 generates an image, the image may be transmitted to the processing unit 16 together with the result of determination.

The processing device 16 provides a service for generating the program of the radar device 12 and adjusting the program (in other words, a provision service or a development service). The processing device 16 provides a service for causing the control device 14 to run the program and sensing the predetermined objects (in other words, an operation service).

The processing device 16 includes a service environment providing unit 42, an authentication management unit 44, a service providing unit 46, and a display unit 48.

The service environment providing unit 42 includes an information storage 52, a program transmitter unit 54, and a service environment controller 56.

The information storage 52 stores a program which is created in advance depending on each type of the radar device 12. The predetermined program is also called a standard program.

The service environment controller 56 reads a standard program corresponding to the type of the radar device 12 selected from a plurality of standard programs stored in the information storage 52. The service environment controller 56 can generate a new program by adjusting information included in the read standard program. The information may be information which specifies the transmission order of the radar modules 22, information which indicates the amplification factor etc., of the received signal based on the positional relationship between each transmitter module and each receiver module, and information which indicates the type of the signal process of the received signal. The information storage 52 also stores the generated program.

Instead of reading a standard program from the information storage 52 and generating a new program by adjusting the read standard program, the service environment controller 56 may newly generate a program corresponding to the type of the radar device 12 without using any standard program.

The information storage 52 also stores device information related to a program for each type of the radar device 12. The device information is information which can be used as reference when the service environment controller 56 newly generates a program.

The program transmitter unit 54 transmits the standard program read by the service environment controller 56 or the program generated by the service environment controller 56 to the control device 14. When the program is run, the control device 14 causes one of the radar modules 22 to transmit electromagnetic waves and causes a plurality of radar modules 22 to receive reflected waves at the same time. The control device 14 causes all of the radar modules 22 to transmit electromagnetic waves by changing the radar module 22 which transmits electromagnetic waves in series.

The authentication management unit 44 authenticates the operator of the processing device 16 before the operation of the service environment controller 56 and before the operation of the service providing unit 46. An authentication key is set for the operator of the processing device 16. The operator is called a developer during the operation of the service environment controller 56 (development phase) and is called an administrator during the operation of the service providing unit 46 (operation phase). The authentication key of the operator includes the authentication key in the development phase (in other words, a developer key) and the authentication key in the operation phase (in other words, an administrator key).

The authentication management unit 44 includes a key input function. The operator of the processing device 16 inputs the authentication key of the operator by using the key input function. The authentication management unit 44 compares the input key with the developer key or the administrator key and determines whether or not the keys are coincident with each other. When the keys are coincident with each other, the authentication of the developer or the administrator succeeds. When the keys are not coincident with each other, the authentication fails.

When the authentication of the operator succeeds, the authentication unit 44 causes the processing device 16 to be operable. When the developer key is authenticated, the authentication management unit 44 causes the service environment providing unit 42 to be operable. When the administrator key is authenticated, the authentication management unit 44 causes the service providing unit 46 to be operable.

The control device 14 may not include the determination unit 34. Instead, the processing device 16 may include the determination unit 34. In this case, the control device 14 transmits the received signal transmitted from the radar device 12 to the processing device 16 as it is or after applying a signal process in some degree. The service providing unit 46 may include an image generation function and determine whether or not the inspection target possesses the predetermined object based on an image.

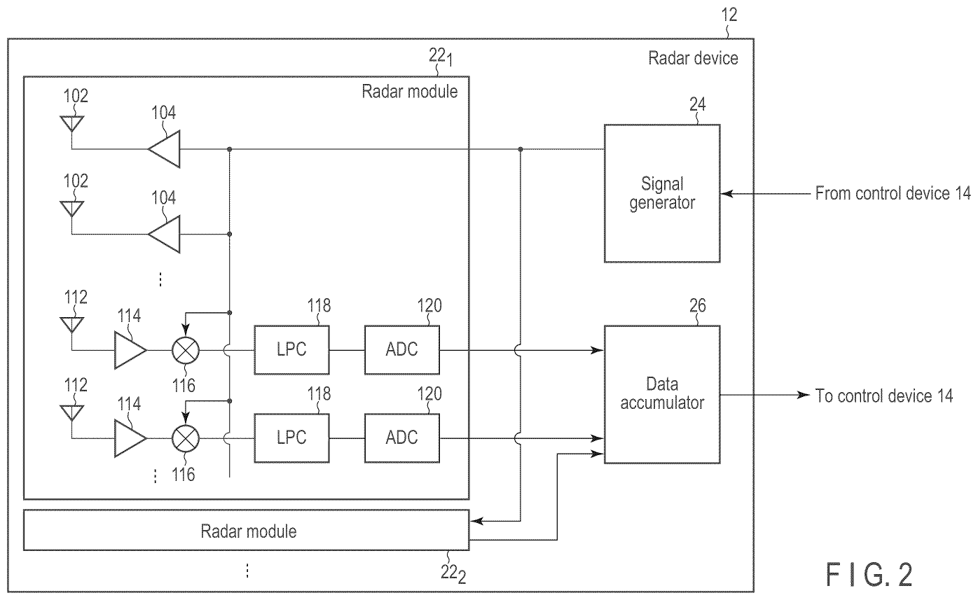

FIG. 2 is a block diagram for explaining an example of the radar device 12 according to the embodiment. The radar device 12 includes a plurality of radar modules. For the sake of convenience, FIG. 2 shows at least two radar modules 221 and 222. Each of the radar modules 22 includes a transmitter unit and a receiver unit to achieve commonality of the structure. However, only one of the transmitter unit and the receiver unit is operated, and the operation of the other one is stopped. In other words, each of the radar modules 22 functions as a transmitter module or a receiver module. The transmitter of each of the radar modules 22 includes a plurality of transmit amplifiers 104 and a plurality of transmit antennas 102. The signal generator 24 generates transmission signals and clock signals. The signal generator 24 supplies the transmission signals to the radar modules 22 at different time points determined by the program. The signal generator 24 supplies the clock signals to all of the radar modules 22 at the same time.

Each of the transmit amplifiers 104 amplifies the transmission signal supplied to a corresponding transmit antenna 102.

The receiver of each of the radar modules 22 includes a receive antenna 112, a receive amplifier 114, a mixer 116, a low-pass filter (LPF) 118, and an analog-to-digital converter (ADC) 120. The mixer 116 mixes a transmission signal and a received signal with each other and generates an intermediate frequency (IF) signal. The IF signal is supplied to the data accumulator 26 via the LPF 118 and the ADC 120.

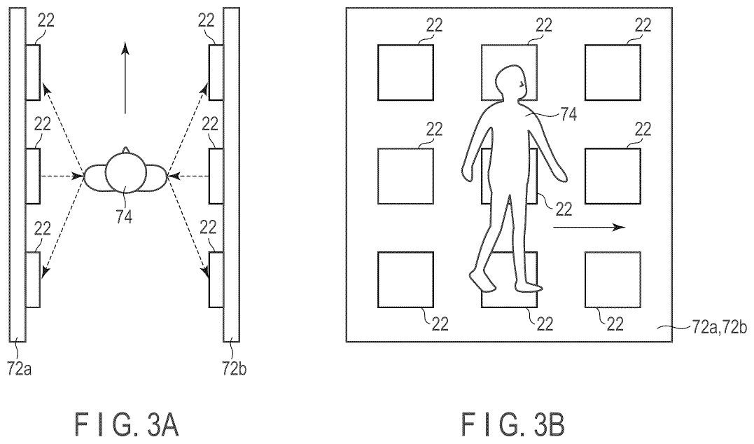

FIG. 3A and FIG. 3B are diagrams for explaining a first example of the layout of the radar modules 22 based on each type of the radar device 12 according to the embodiment. FIG. 3A and FIG. 3B show a layout example of the radar modules 22 in a gate type radar device. FIG. 3A is a diagram in which the inspection target 74 is viewed from the top side. FIG. 3B is a diagram in which the inspection target 74 is viewed from a lateral side.

In the gate type radar device, the radar modules 22 are provided on both the left side and the right side of a passage in front of the entrance (gate) of the area in which the security should be ensured. The inspection target 74 walks through the passage. A plurality of radar modules 22 are provided in both the left sidewall 72a and the right sidewall 72b of the passage. A plurality of (for example, 3×3) radar modules 22 are provided in each of the sidewalls 72a and 72b. The control device 14 or the processing device 16 may cause the gate to close when the procession of a predetermined object is determined. This configuration prevents the inspection target 74 who possesses a predetermined object from passing through the gate, thereby ensuring the security of the area.

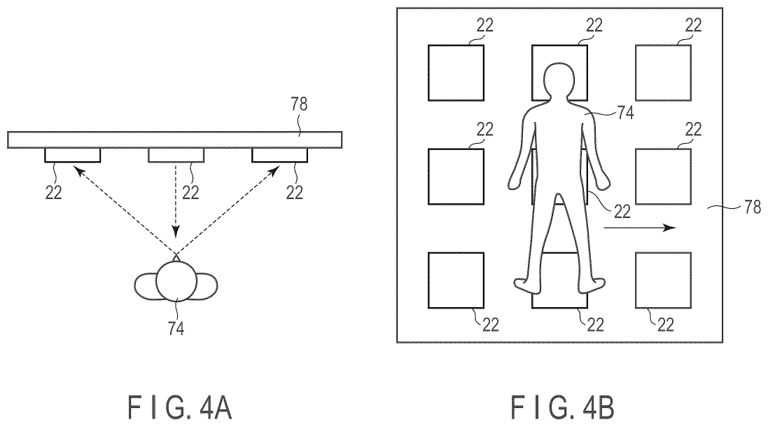

FIG. 4A and FIG. 4B are diagrams for explaining a second example of the layout of the radar modules 22 based on each type of the radar device 12 according to the embodiment. FIG. 4A and FIG. 4B show a layout example of the radar modules 22 in a fixed wall type radar device. FIG. 4A is a diagram in which the inspection target 74 is viewed from the top side. FIG. 4B is a diagram in which the inspection target 74 is viewed from the back side.

In the fixed wall type radar device, the radar modules 22 are provided in a wall 78 of the room in which the security should be ensured. The inspection target 74 is located on the front side of the wall 78. A plurality of (for example, 3×3) radar modules 22 are provided in the wall 78. The control device 14 or the processing device 16 may notify the manager of the room of the identification information of the inspection target 74 who possesses a predetermined object when the possession of the predetermined object is determined. The determination unit 34 may obtain the identification information of the inspection target 74 by applying a signal process to the received signal. As the manager can cope with the situation by, for example, making the inspection target 74 leave the room, the security of the room is ensured.

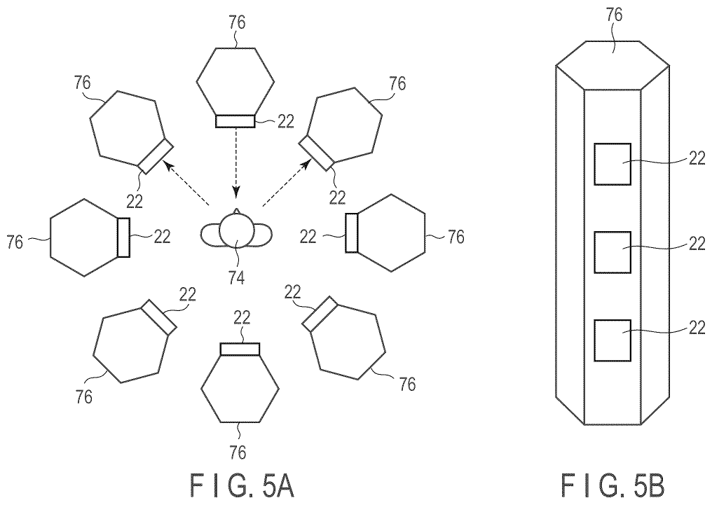

FIG. 5A and FIG. 5B are diagrams for explaining a third example of the layout of the radar modules 22 according to the embodiment. FIG. 5A and FIG. 5B show a layout example of the radar modules 22 in a pole type radar device 12. FIG. 5A is a diagram in which the inspection area is viewed from the top side. The radar modules 22 of the pole type radar device 12 is provided on each of a plurality of poles 76 arranged so as to surround the area (for example, a circular area) in which the security should be ensured. FIG. 5B is a diagram in which the pole 76 is viewed from the center of the area. A plurality of (for example, three) radar modules 22 are provided on the side surface of the pole 76 which faces the center of the area. The control device 14 or the processing device 16 may notify the guard of the area of the identification information of the inspection target 74 which possesses a predetermined object when the possession of the predetermined object is determined. As the guard can cope with the situation by, for example, making the inspection target 74 leave the area, the security of the area is ensured.

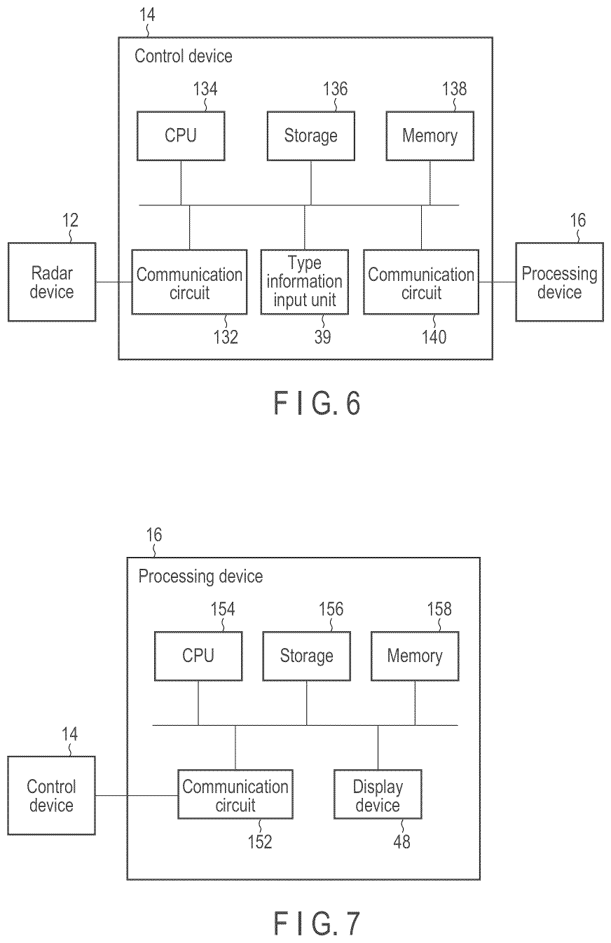

FIG. 6 is a block diagram for explaining an example of the control device 14 according to the embodiment. The control device 14 includes a communication circuit 132 connected to the radar device 12, a communication circuit 140 connected to the processing device 16, a CPU 134 which runs a program, a storage 136 which stores a program, a memory 138 which stores data and the type information input unit 39. The number of CPUs 134 is not limited to one. A plurality of CPUs may be provided such that they correspond to the respective functions shown in FIG. 1 or each of the CPUs corresponds to a plurality of functions shown in FIG. 1. Instead of the CPU 134, a GPU or an FPGA may be used. Examples of the storage 136 include an SSD. Examples of the memory 138 include a DRAM.

The CPU 134 realizes the functions of the radar module authentication unit 32, the determination unit 34, and the controller 38 by running a program.

FIG. 7 is a block diagram for explaining an example of the processing device 16 according to the embodiment. The processing device 16 includes a communication circuit 152 connected to the control device 14, a CPU 154 which runs a program, a storage 156 which stores a program, a memory 158 which stores data, and the display unit 48. The number of CPUs 154 is not limited to one. A plurality of CPUs may be provided such that they correspond to the respective functions shown in FIG. 1 or each of the CPUs corresponds to a plurality of functions shown in FIG. 1. Instead of the CPU 154, a GPU or an FPGA may be used. Examples of the storage 156 include an SSD. Examples of the memory 158 include a DRAM.

The CPU 154 realizes the functions of the service environment providing unit 42, the authentication management unit 44, and the service providing unit 46 by running the program stored in the storage 156.

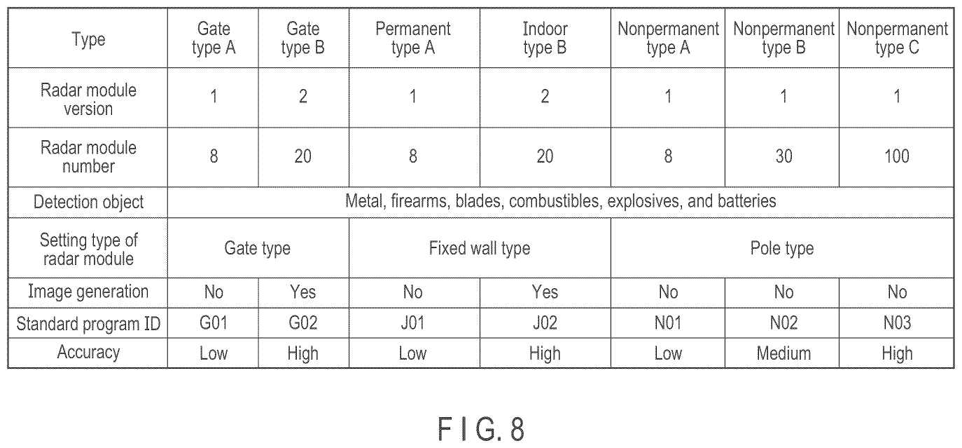

FIG. 8 is a diagram for explaining an example of device information stored in the information storage 52 for each type according to the embodiment. The device information indicates at least one of the installation location of the radar device 12 and the radar module configuration. Examples of the device information include the version of the radar modules 22, the number of radar modules 22, the types of detection objects, the type of setting of the radar modules 22, whether or not an image is generated, standard program ID and the accuracy.

The type of setting relates to a physical combination of the radar modules 22. Examples of the type of setting include a gate type, a fixed wall type, and a pole type. When the type of setting is a gate type, the radar modules 22 are arranged as shown in FIG. 3. When the type of setting is a fixed wall type, the radar modules 22 are arranged as shown in FIG. 4. When the type of setting is a pole type, the radar modules 22 are arranged as shown in FIG. 5.

When the type of setting is a gate type, the type of the radar device may be gate type A and gate type B. When the type of setting is a fixed wall type, the type of the radar device may be permanent type A and indoor type B. When the type of setting is a pole type, the type of the radar device may be nonpermanent type A, nonpermanent type B and nonpermanent type C. A standard program is created in advance based on each type and is stored in the information storage 52.

Examples of the installation location of the radar device of gate type A include the gates of a rail station and an airport. Examples of the installation location of the radar device of gate type B include the gates of a company, public facilities, an amusement park, and a concert hall. Examples of the installation location of the radar device of permanent type A include an elevator and an art museum. Examples of the installation location of the radar device of indoor type B include a court and the bullet train. Examples of the installation location of the radar device of nonpermanent type A include a small-scale event site. Examples of the installation location of the radar device of nonpermanent type B include a medium-scale event site and a campaign speech meeting. Examples of the installation location of the radar device of nonpermanent type C include a large-scale event site and a campaign speech meeting.

The inspection accuracy of the radar device of gate type B is higher than that of the radar device of gate type A. The inspection accuracy of the radar device of indoor type B is higher than that of the radar device of permanent type A. The inspection accuracy of the radar device of nonpermanent type B is higher than that of the radar device of nonpermanent type A. The inspection accuracy of the radar device of nonpermanent type C is higher than that of the radar device of nonpermanent type B.

The service environment providing unit 42 creates the standard programs corresponding to the types of the radar device 12 in advance and stores the standard programs in the information storage 52 before the development phase of the processing device 16. Thus, the standard programs include a large number of programs which are different from each other in terms of the number of radar modules 22, the version, the type of the inspection target, the type of setting of the radar modules 22, whether or not an image is generated, and the inspection accuracy.

The layout of the radar modules 22 can be adjusted. In the case of the gate types, the locations of the radar modules 22 can be changed in a vertical direction and a horizontal direction within each side surface. In the case of the permanent type, the locations of the radar modules 22 can be changed in a vertical direction and a horizontal direction within the wall, and can be also changed in a depth direction orthogonal to the wall. In the case of the nonpermanent types, the locations of the poles can be changed within a horizontal plane, and the locations of the radar modules 22 in each pole can be changed in a vertical direction.

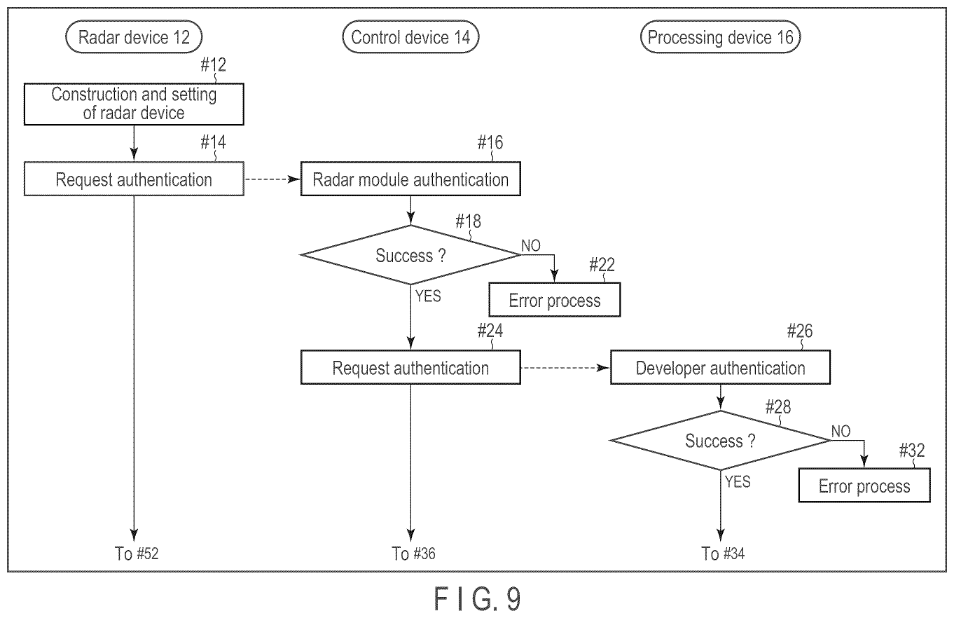

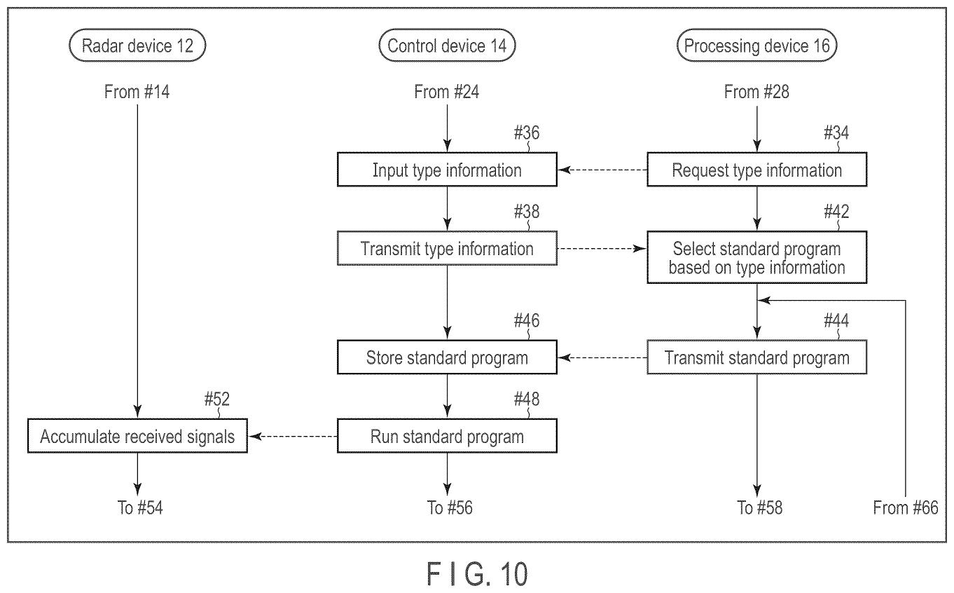

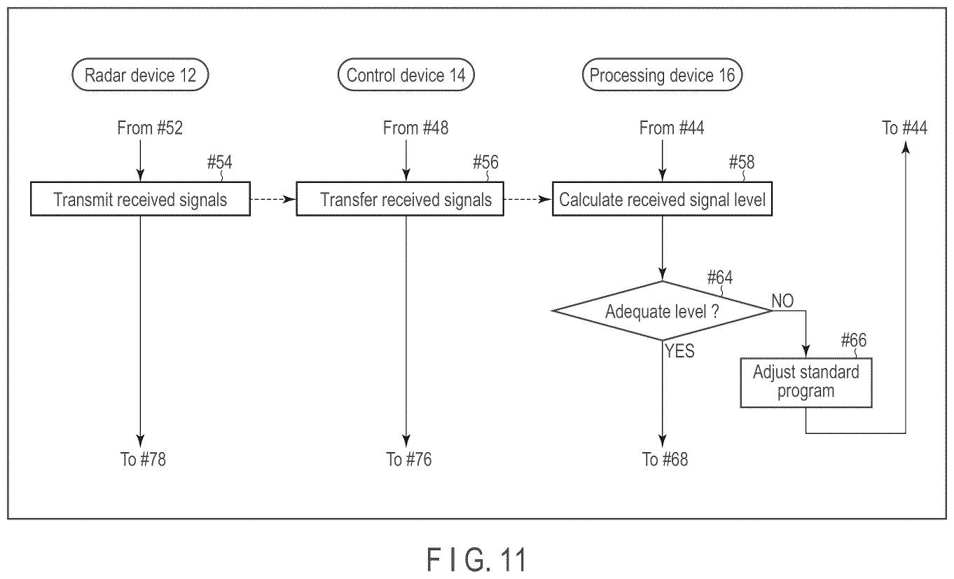

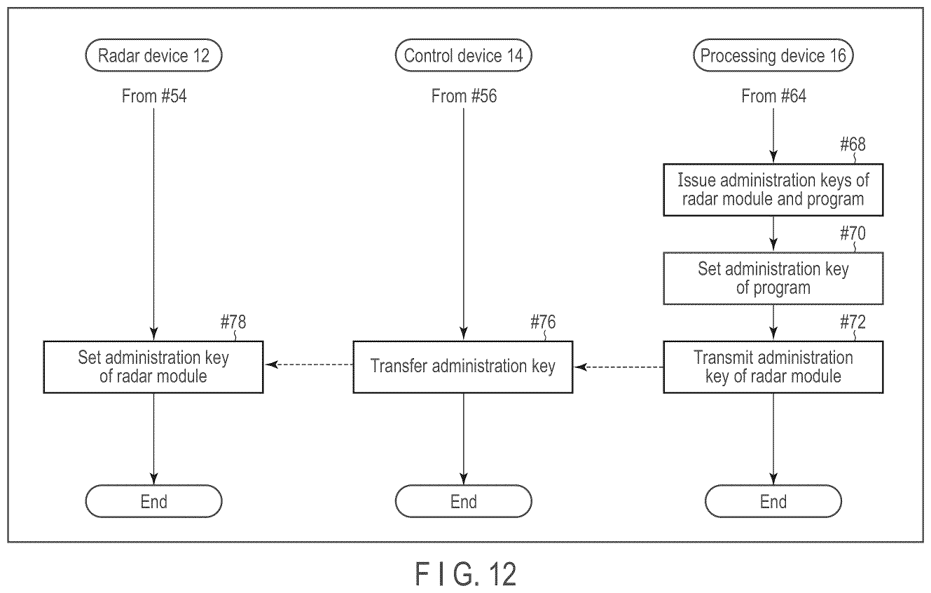

FIG. 9 to FIG. 12 are diagrams for explaining an example of a process in the development phase of the processing device 16 according to the embodiment.

The developer constructs and sets the radar device 12 by arranging a plurality of radar modules 22 based on the type (#12).

When an instruction to start development is issued after the completion of the construction and installation of the radar device 12, the radar device 12 transmits an authentication request of each radar module to the control device 14 (#14). The radar device 12 may include a development start switch. The radar device 12 may transmit the authentication request to the control device 14 when the development start switch is operated.

The control device 14 performs radar module authentication by the radar module authentication unit 32 when the authentication request is received (#16). The developer inputs the authentication key of each radar module by using the radar module authentication unit 32. The radar module authentication unit 32 determines whether the authentication for each radar module succeeds or fails (#18). When the authentication for all of the radar modules 22 succeeds, the radar module authentication unit 32 determines that the authentication succeeds. When the authentication for at least one radar module 22 fails, the radar module authentication unit 32 determines that the authentication fails.

When the authentication fails, the control device 14 performs an error process (#22) and terminates the operation. For example, the error process includes the display of an authentication failure in a display unit (not shown).

When the authentication succeeds, the control device 14 transmits an authentication request of the developer to the processing device 16 (#24). When the processing device 16 receives the authentication request, the authentication management unit 44 performs developer authentication (#26). The developer inputs the authentication key of the developer, which is the developer kay, by using the authentication management unit 44. The authentication management unit 44 determines whether the authentication succeeds or fails (#28).

When the authentication fails, the authentication management unit 44 performs an error process (#32) and terminates the operation. For example, the error process includes the display of an authentication failure in the display unit 48.

When the authentication succeeds, the service environment controller 56 requests the control device 14 for type information (#34). When the control device 14 receives the type information request, the controller 38 obtains the type information by using the type information input unit 39 (#36). The type information input unit 39 may be either a keyboard to which the developer inputs the type information or a receiver which receives the type information transmitted from the radar device 12. The controller 38 transmits the type information to the processing device 16 (#38). When the authentication succeeds (#28, YES), the service environment controller 56 may input the type information of the radar device by using a keyboard (not shown) etc., instead of requesting the control device 14 for the type information (#34). In this case, the type information is not transmitted from the control device 14 to the processing device 16. When the processing device 16 receives the type information, the service environment controller 56 selects a standard program based on the type information of the radar device 12 from the standard programs stored in the information storage 52, and reads the selected standard program from the information storage 52 (#42). The service environment controller 56 transmits the standard program to the control device 14 (#44).

When the control device 14 receives the standard program, the control device 14 stores the standard program in the program storage 36 (#46). The controller 38 runs the standard program (#48).

The controller 38 drives and controls the radar device 12 in sequence in accordance with the standard program. In the radar device 12, one of the radar modules 22 transmits electromagnetic waves, and all of the radar modules 22 receive the waves reflected on portions of the inspection target. The standard program includes information which specifies the transmission order of the radar modules 22, information which indicates the amplification factor etc., of the received signal based on the positional relationship between each transmitter module and each receiver module, information which indicates the type of the signal process of the received signal and the like.

The received signal from each of the radar modules 22 is supplied to the data accumulator 26 and the received signals from the radar modules 22 are accumulated in the data accumulator 26 (#52). The data accumulator 26 transmits the received signals to the control device 14 (#54). When the control device 14 receives the received signals, the control device 24 transfers the received signals to the processing device 16 (#56).

When the processing device 16 receives the received signals, the service environment controller 56 calculates the levels of the received signals (#58). The service environment controller 56 determines whether or not each of the levels of the received signals is an adequate level to inspect the predetermined object (#64).

When the level of the received signal is not an adequate level for the inspection of the predetermined object (#64: No), the service environment controller 56 adjusts the standard program by changing information of the program and stores the adjusted program in the information storage 52 (#66). In the service environment controller 56, a plurality of information items which are changeable based on the standard program and their changed value candidates are set. The changeable information items and their changed value candidates can be set by learning using AI. In an adjustment of one time, the service environment controller 56 changes the value of an information item. Examples of the adjustment of the program include an adjustment of information indicating the transmission order of the radar modules 22, the amplification factor of the received signal for each of the radar modules 22 and the like. The level of the received signal changes based on the relationships among the inspection target, the transmitter module, and the receiver module. Therefore, in a case where the received signal level is not an adequate level for the inspection of the predetermined object, when the amplification factor of each received signal is adjusted based on the positional relationship between the transmitter module and the receiver module, a received signal having an adequate level for the inspection of the predetermined object can be obtained.

The service environment controller 56 transmits the adjusted program to the control device 14 (#44). The radar device 12 is driven and controlled again by the adjusted program, and the levels of the received signals are determined again. When the received signal level is not an adequate level, the adjustment of the program is continued.

When the levels of the received signals are adequate levels to inspect the predetermined object (S64: Yes), this result of determination shows that a program which is suitable for the radar device 12 is selected or adjusted. The selected or adjusted program is stored in the information storage 52.

The service environment controller 56 issues the administration key of each of the radar modules 22 and the administration key of the program (#68). The service environment controller 56 sets the administration key of the program stored in the information storage 52 (#70). After this point, the authentication of the administration key is required to read the program from the information storage 52. The service environment controller 56 transmits the administration key of each radar modules to the control device 14 (#72).

When the control device 14 receives the administration key of each of the radar modules 22, the control device 14 transfers the administration key of each of the radar modules 22 to the radar device 12 (#76). When the radar device 12 receives the administration key of each of the radar modules 22, the radar device 12 sets the administration key of each of the radar modules 22 (#78). After this point, the authentication of the administration keys of the radar modules 22 is required to operate the radar device 12.

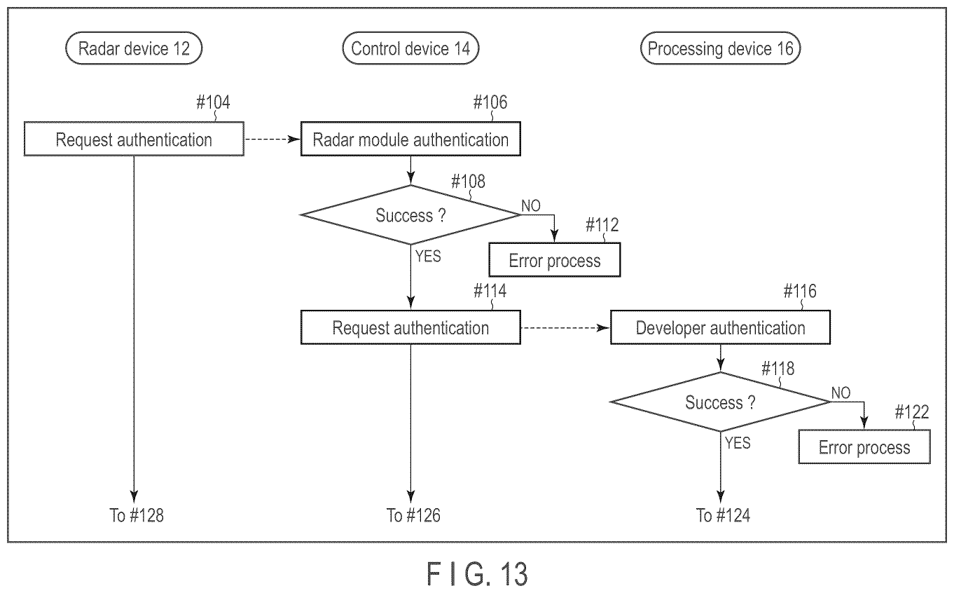

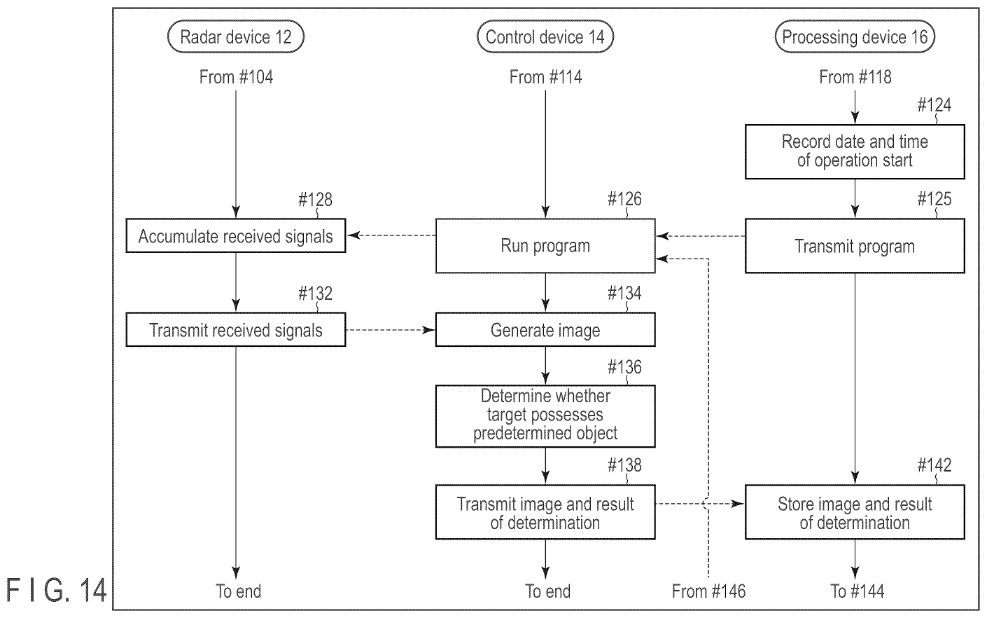

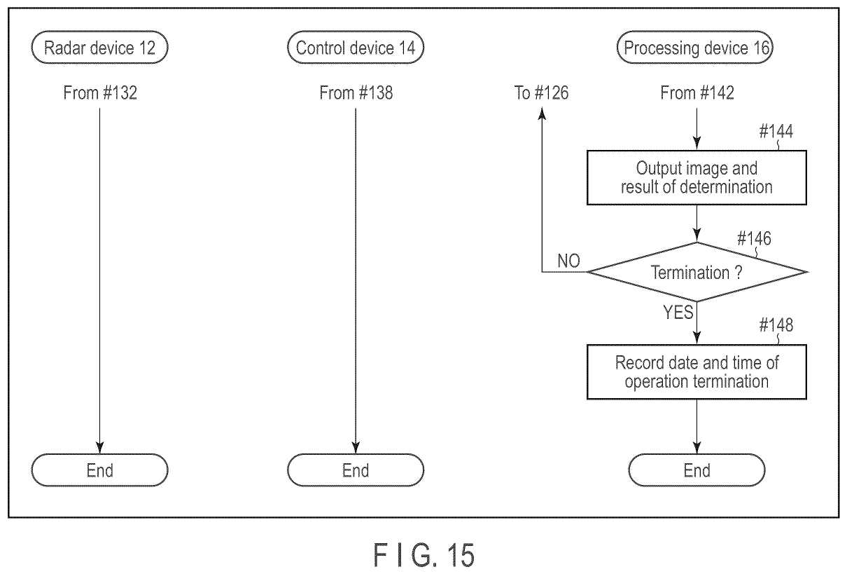

FIG. 13 to FIG. 15 are diagrams for explaining an example of a process in the operation phase of the processing device 16 according to the embodiment.

When an instruction to start the operation of the radar system is issued, the radar device 12 transmits the authentication request of the radar modules 22 to the control device 14 (#104). The radar device 12 may include an operation start switch. The radar device 12 may transmit an authentication request to the control device 14 when the operation start switch is operated.

The control device 14 performs radar module authentication by the radar module authentication unit 32 when the authentication request is received (#106). The administrator inputs the authentication key (administration key) of each of the radar modules 22. The control device 14 determines whether the authentication succeeds or fails (#108).

When the authentication fails, the control device 14 performs an error process (#112) and terminates the operation. For example, the error process includes the display of an authentication failure in the display unit (not shown).

When the authentication succeeds, the control device 14 transmits the authentication request of the administrator to the processing device 16 (#114). This authentication request is accompanied by the type information of the radar device 12. When the processing device 16 receives the authentication request, the authentication management unit 44 performs administrator authentication (#116). The administrator inputs the authentication key of the administrator, which is the administrator key, by using the authentication management unit 44. The authentication management unit 44 determines whether the authentication succeeds or fails (#118).

When the authentication fails, the processing device 16 performs an error process (#122) and terminates the operation. For example, the error process includes the display of an authentication failure in the display unit 48.

When the authentication succeeds, the service providing unit 46 records the date and time of the operation start in the information storage 52 (#124). This is information which is necessary in a case where a fee is charged in accordance with the operation time of the radar system and the period of time.

The service providing unit 46 reads the standard program or the adjusted program from the information storage 52 based on the type information accompanying the authentication request of the administrator and transmits the program to the control device 14 (#125).

When the control device 14 receives the program, the control device 14 stores the program in the program storage 36 and causes the controller 38 to run the program. The controller 38 drives and controls the radar device 12 in a sequence in accordance with the program (#126). In the radar device 12, the radar modules 22 transmit electromagnetic waves, and the radar modules 22 receive the waves reflected on each portion of the inspection target. The received signal from each radar module is supplied to the data accumulator 26 (#128). The data accumulator 26 transmits the received signals to the control device 14 (#132).

When the control device 14 receives the received signals, in a case where the program gives an instruction to generate an image, the control device 14 causes the determination unit 34 to generate an image (#134). The controller 38 applies a signal process to the image and determines whether or not the target possesses the predetermined object (#136). The controller 38 transmits the image and the result of determination to the processing device 16 (#138). When the processing device 16 receives the image and the result of determination, the processing device 16 stores the image and the result of determination in the information storage 52 (#142). The processing device 16 outputs the image and the result of determination (#144). Examples of the output include display by the display unit 48.

The processing device 16 determines whether or not an instruction to terminate the operation is issued (#146). When an instruction to terminate the operation is not issued, the processing device 16 causes the control device 14 to run the program (#126).

When an instruction to terminate the operation is issued, the service providing unit 46 records the date and time of the operation termination in the information storage 52 (#148) and terminates the operation. The information of the date and time of the operation termination is information which is necessary in a case where a fee is charged in accordance with the operation time of the radar system and the period of time.

The processing device 16 may include an operation termination switch. The processing device 16 may determine that the operation is terminated when the operation termination switch is operated.

In a case where the control device 14 does not include the determination unit 34, and the processing device 16 includes the function of the determination unit 34, the control device 14 does not perform image generation (#134), image determination (#136) or image/determination result transmission (#138). The control device 14 transmits the received signal transmitted from the radar device 12 to the processing device 16 as it is or after applying a signal process in some degree. The processing device 16 performs image generation (#134), image determination (#136), and image/determination result transmission (#138) in place of the control device 14.

According to the embodiment, the processing device 16 stores the standard program which is created in advance based on the type of the radar device 12. Thus, the processing device 16 can transmits the program corresponding to the type of the radar device 12 to the control device 14. When the received signal obtained by the standard program does not have an adequate level for the inspection of the predetermined object, the processing device 16 can adjust the standard program. When the radar device 12 is used, the authentication of each radar module is needed. This configuration prevents an unauthorized inspection of the inspection target using an unauthenticated radar module. The processing device 16 requires the authentication of the operator and the authentication of the program to adjust the standard program. This configuration prevents an unauthorized adjustment of the standard program. When the processing device 16 causes the control device 14 to run the standard program, the authentication of the operator is needed. This configuration prevents the operator from performing an unauthorized inspection of the inspection target using the radar device 12.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
a sensor device in which at least one of an installation location and a configuration is changeable;
a control device configured to drive the sensor device and process a sensor signal output from the sensor device; and
a processing device configured to
store device information indicating at least one of the installation location and the configuration for each type,
receive type information indicating a type of the sensor device, and
transmit a program based on the type information and the device information to the control device.

2. The system of claim 1, wherein
the control device is configured to drive the sensor device and process the sensor signal based on the program.

3. The system of claim 1, wherein
the processing device is able to transmit a program by which the control device generates an image based on the sensor signal to the control device or a program by which the control device does not generate the image to the control device.

4. The system of claim 1, wherein
the control device is able to transmit a processing result of the sensor signal to the processing device, and
the processing device is able to transmit a program by which the control device generates an image based on the sensor signal to the control device or a program by which the control device does not generate the image to the control device.

5. The system of claim 1, wherein
the control device is able to perform determination regarding whether or not an inspection target includes a predetermined object based on the sensor signal, and
the processing device is able to transmit one of at least two programs which differ from each other in terms of accuracy of inspection of the inspection target to the control device.

6. The system of claim 1, wherein
the control device comprises an input device configured to input the type information.

7. The system of claim 6, wherein
the input device is configured to receive the type information from the sensor device.

8. The system of claim 1, wherein
the sensor device comprises a radar or an image recognition device.

9. The system of claim 1, wherein
the processing device is configured to determine whether or not the program is appropriate based on the sensor signal generated when the control device drives the sensor device based on the program, and
when the processing device determines that the program is not appropriate, the processing device is configured to adjust the program and transmit the adjusted program to the control device.

10. The system of claim 1, wherein
the processing device comprises a memory configured to store standard programs for respective types, and
the processing device is configured to
select one of the standard programs based on the type information, and
determine whether or not the selected standard program is appropriate based on the sensor signal which is generated when the control device drives the sensor device based on the standard program, and
the processing device is configured to adjust the standard program and transmit the adjusted program to the control device when the processing device determines that the selected standard program is not appropriate.

11. The system of claim 1, wherein
the processing device is configured to
generate a program based on the type information and the device information, and
transmit the generated program to the control device.

12. The system of claim 1, wherein
the installation location is a sidewall of a passage, a wall of a room, or a pole.

13. The system of claim 1, wherein
the sensor device comprises a plurality of sensor modules, and
the configuration is the number of the sensor modules, a version of the sensor modules, a type of an inspection target, or whether or not an image is generated.

14. A processing device for driving a sensor device in which at least one of an installation location and a configuration is changeable, and the processing device connected to a control device configured to process a sensor signal output from the sensor device, the processing device is configured to
store device information indicating at least one of the installation location and the configuration for each type,
receive type information indicating a type of the sensor device, and
transmit a program based on the type information and the device information to the control device.

15. A non-transitory computer readable storage medium having stored there on a computer program which is executable by one or more computers for controlling a system comprising a sensor device in which at least one of an installation location and a configuration is changeable; a control device configured to drive the sensor device and process a sensor signal output from the sensor device; and a processing device configured to store device information indicating at least one of the installation location and the configuration for each type, the computer program configured to cause the one or more computers to execute functions of:
receive type information indicating a type of the sensor device; and
transmit a program based on the type information and the device information to the control device.
